(19) United States
(12) Patent Application Publication
(10) Pub. No.: US 2016/0344225 A1
(43) Pub. Date: Nov. 24, 2016

(54) Wireless recharging system for mobile electronic devices

(71) Applicant: Ruben Bailey, Corning, NY (US)

(72) Inventor: Ruben Bailey, Corning, NY (US)

(21) Appl. No.: 15/161,976

(22) Filed: May 23, 2016

Related U.S. Application Data
(60) Provisional application No. 62/164,850, filed on May 21, 2015.

(51) Int. Cl. H02J 7/02; B60L 11/18

(52) U.S. Cl. CPC H02J 7/025; H02J 7/027; B60L 11/182; H02J 2007/0096

(57) ABSTRACT

A wireless recharging system for mobile electronic devices charges mobile electronic devices wirelessly. The recharging system is comprised of two components. The first component may be plugged into standard household current. The second component may be plugged into any one of several standard data ports on a tablet, smartphone, or other mobile electronic device. The first component may provide an LED reading, which shows the battery life percentage of the electronic device being charged, and transfers electric power to the second component via resonant inductive coupling, creating an oscillating magnetic field which is converted to electricity by the second component. The system further provides a mobile application which may be installed on the user's electronic device to operate the system.

### CROSS-REFERENCE TO RELATED APPLICATIONS

This application claims the benefit of U.S. Provisional Application No. 62/164,850, filed 21 May 2015, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to accessories for mobile electronic devices and in particular to a wireless recharging system for mobile electronic devices. The smartphone, laptop, and tablet have completely transformed our way of life. Our research and communications abilities have been vastly improved by these devices. Unfortunately, they are battery-powered and the batteries still have to be recharged. Conventional recharging devices are very cumbersome, hampering the very mobility that is the principal attraction of using a mobile electronic device. Furthermore, the power cables can become tangled and are easily lost or damaged. Existing technology from the field of medical devices and implants provides the solution. A wireless recharging system, which is capable of recharging the battery in a user's mobile electronic device without direct contact, would resolve this problem.

### SUMMARY OF THE INVENTION

Accordingly, the invention is directed to a wireless recharging system for mobile electronic devices. The recharging system is comprised of two components. The first component may be plugged into standard household current. The second component may be plugged into any one of several standard data ports on a tablet, smartphone, or other mobile electronic device. The first component may provide an LED reading, which shows the battery life percentage of the electronic device being charged, and transfers electric power to the second component via resonant inductive coupling, creating an oscillating magnetic field which is converted to electricity by the second component. The system further provides a mobile application which may be installed on the user's electronic device to operate the system.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitutes a part of the specification. They illustrate two embodiments of the invention and, together with the description, serve to explain the principles of the invention.

FIG. 1 is a front view of the transmission component of the first exemplary embodiment, displaying the first component 10, and the LED display 11.

FIG. 2 is a rear view of the transmission component of the first exemplary embodiment with the prongs in the folded position, displaying the first component 10, and the prongs 12.

FIG. 3 is a side perspective view of the transmission component of the first exemplary embodiment with the prongs in the folded position, displaying the first component 10, and the prongs 12.

FIG. 4 is a side perspective view of the transmission component of the first exemplary embodiment with the prongs in the extended position, displaying the first component 10, and the prongs 12.

FIG. 5 is a top view of the transmission component of the first exemplary embodiment, displaying the first component 10.

FIG. 6 is a top view of the receiving component of the first exemplary embodiment, displaying the second component 13.

FIG. 7 is a top view of the receiving component of the first exemplary embodiment, displaying the second component 13.

FIG. 8 is an internal view of the transmission component, displaying the internal transmission coil and the capacitor.

FIG. 9 is an internal view of the receiving component, displaying the internal receiving coil and the rechargeable battery.

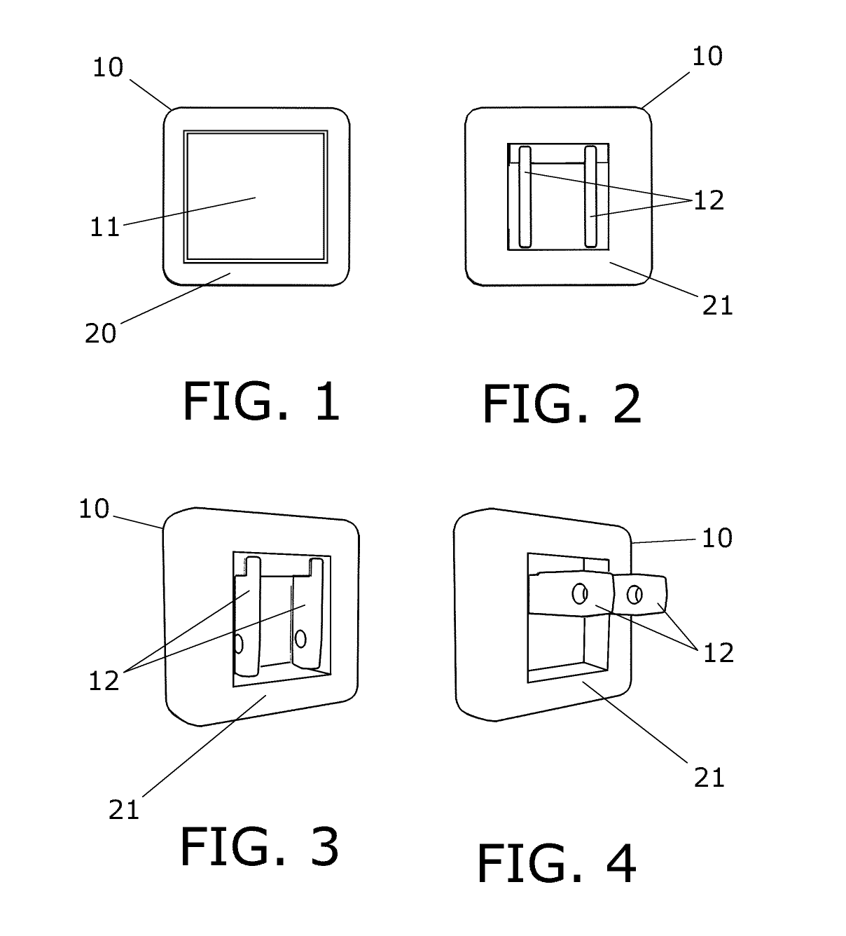

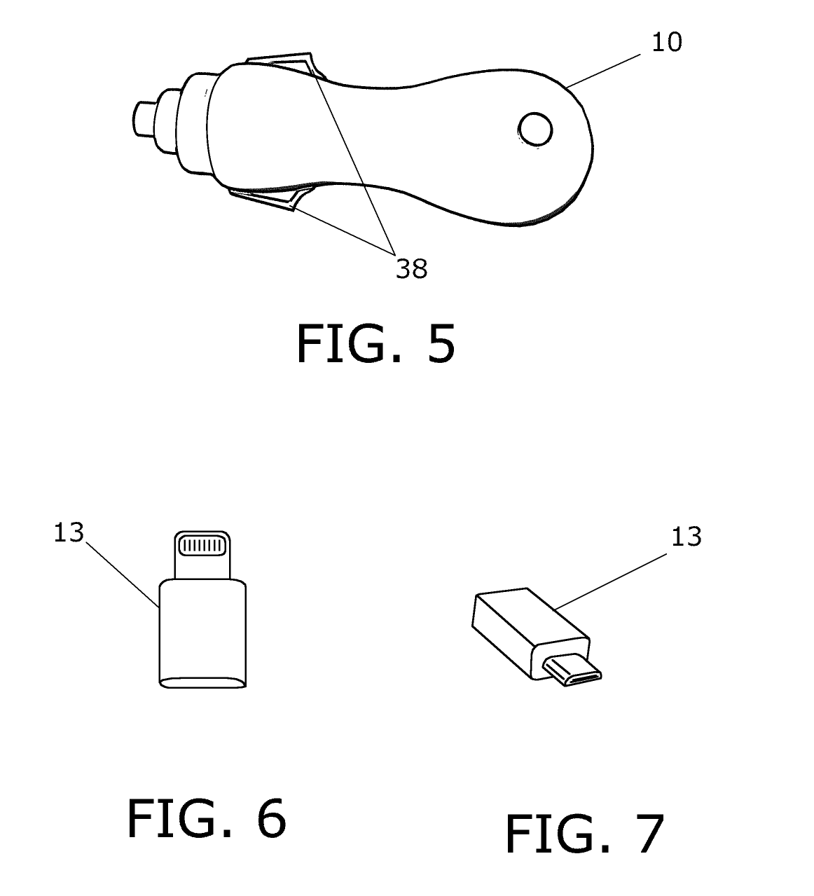

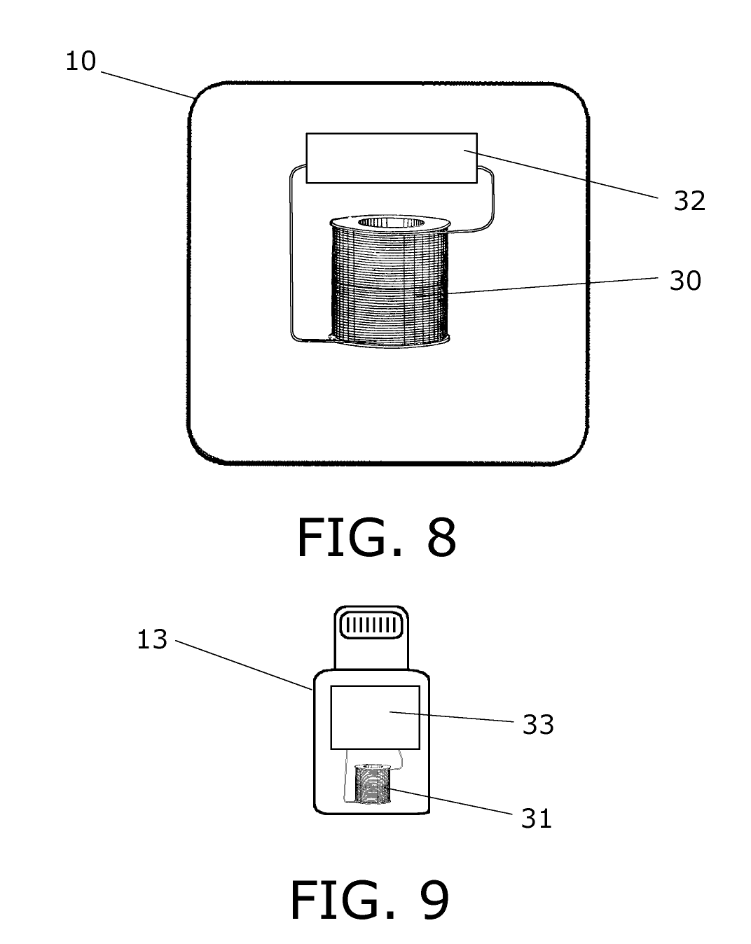

### DETAILED DESCRIPTION OF THE INVENTION

Referring now to the invention in more detail, the invention is directed to a wireless recharging system for mobile electronic devices.

The first exemplary embodiment is comprised of two components. The first component is a transmission component 10. The transmission component 10 may be plugged into standard household current with two folding prongs 12 on the rear surface 20, and provides a light emitting diode (LED) display 11 on the front surface 21. The second component is a receiving component 13. The receiving component may be plugged into any power port of a device. Preferably, the power port is any one of several standard data ports on a tablet, smartphone, or other mobile electronic device. The transmission component 10 transfers electric power to the receiving component 13 via resonant inductive coupling. The transmission component 10 converts electrical power from the wall outlet into an oscillating magnetic field. The oscillating magnetic field is converted back to electrical power by the receiving component 13. The receiving component 13 then transfers the electrical power to the mobile electronic device.

The transmission component 10 and the receiving component 13 are also capable of wirelessly communicating data. For instance, the receiving component 13 is capable of reading the battery level of the mobile electronic device and communicating the battery level to the transmission component 10. The LED display 11 provides a visual readout of the battery life percentage of the electronic device being charged. The receiving component 13 is also capable of communicating whether the receiving component 13 is connected to a mobile electronic device. The system is automatically activated when the transmission component 10 is within 30 feet of an electronic device which is less than fully charged and has the receiving component 13 plugged into a data port. The system automatically deactivates when the mobile electronic device is fully charged or is disconnected from the receiving component 13.

It is to be understood that while the invention is intended for use with personal mobile electronic devices, this is not intended as a limitation. The invention, with suitable modifications, may be used to recharge any device powered by rechargeable batteries, such as electric and hybrid vehicles.

The first exemplary embodiment provides a transmission component 10 which is preferably square in shape, with an internal transmission magnetic coil 30 which generates an oscillating magnetic field upward and outward from a field projector. The magnetic field is converted to electric power by the receiving component 13, which features an internal receiving magnetic coil 31. The magnetic oscillations are produced by discharging voltage from a capacitor 32 into a coil 30, such that the capacitor and coil are in an electrical loop. No other components will deter from the natural oscillations which result from the electrical current varying in direction as it goes through the coil 30, producing the magnetic field.

The receiving component 13 may be connected to a mobile electronic device via any one of several standard data ports, preferably a Universal Service Bus (USB) or Micro-USB port. The receiving component 13 also features a rechargeable internal battery 33. At short ranges, such as five feet or less, electric power converted from the transmission component 10 may be used simultaneously to recharge the internal battery 33 of the receiving component, as well as recharge the battery of the mobile electronic device, and operate the mobile electronic device at full power.

The system is make-specific, such that only electronic devices produced by a single manufacturer may be recharged by the system, regardless of the compatibility of the data ports of electronic device produced by other manufacturers.

Other electronic components of the transmission component 10 include a capacitor 32, a magnetic coil 31, an internal antenna, a touchscreen visual display 11, a microprocessor, and a memory device. Electronic components of the receiving component include a magnetic coil 32, a rechargeable battery or batteries 33, and the necessary switches to divert electric power as desired to recharging the battery of the electronic device, recharging the battery 33 of the receiving component 13, or both. The 30-foot range of the system is several times greater than the conventional power cord or wired recharging device, although the effectiveness of the system is inversely proportional with the range.

To use the first exemplary embodiment, the user may unfold the prongs 12 on the rear surface 20 of the transmission component 10 and plug it into a standard wall outlet, then plug the receiving component 13 into a data port of the user's electronic device, using the plug which is provided. When recharging is completed, the user may disconnect the electronic device from the receiving component 13.

The second exemplary embodiment is similar in structure and function to the first exemplary embodiment with the following modifications. The transmission component 10 is preferably peanut-shaped and does not provide prongs 12. Instead, the transmission component 10 is configured with electrical connectors 38 such that it may be plugged into the auxiliary AC socket of a vehicle and receive power therefrom.

To use the second exemplary embodiment, the user may plug the transmission component 10 into the auxiliary socket of a vehicle, then plug the receiving component 13 into a data port of the user's electronic device, using the plug which is provided. When recharging is completed, the user may disconnect the electronic device from the receiving component 13.

The transmission component 10 and the receiving component are preferably manufactured from rigid, durable materials such as steel, aluminum alloy, copper alloy, brass, and plastic. Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A wireless recharging system, comprising:
a. a transmission component;
b. a receiving component;
c. said transmission component being capable of receiving electrical power from a power source;
d. said transmission component comprising an internal transmission magnetic coil capable of converting electrical power into a magnetic field and a capacitor in electrical loop with the magnetic coil such that the magnetic field is an oscillating magnetic field;
e. said receiving component comprising an internal receiving magnetic coil capable of converting the oscillating magnetic field into electrical power and a rechargeable battery;
f. said rechargeable battery being physically connected to the receiving magnetic coil such that the electrical power from said receiving magnetic coil charges the rechargeable battery;
g. said receiving component being configured to plug into a power port such that the receiving component provides power to a rechargeable battery via said power port.
h. said receiving component being capable of transmitting data to said transmission component;
i. said transmission component providing a display on the front surface; and
j. said display being capable of displaying the data received by the transmission component from the receiving component.

2. The wireless recharging system of claim 1, wherein said power source is a wall outlet; said transmission component providing two prongs on a rear surface which are capable of plugging into the wall outlet and transmitting power from the wall outlet to the capacitor and internal transmission magnetic coil.

3. The wireless recharging system of claim 2, wherein said two prongs are configured to movably fold into a stored position wherein the prongs are hidden within the transmission component.

4. The wireless recharging system of claim 1, wherein said transmission component is square in shape.

5. The wireless recharging system of claim 2, wherein said transmission component is square in shape.

6. The wireless recharging system of claim 1, wherein said display is a light emitting diode display.

7. The wireless recharging system of claim 2, wherein said display is a light emitting diode display.

8. The wireless recharging system of claim 4, wherein said display is a light emitting diode display.

9. The wireless recharging system of claim 5, wherein said display is a light emitting diode display.

10. The wireless recharging system of claim 1, wherein said power port is a standard data port on a mobile electronic device.

11. The wireless recharging system of claim 2, wherein said power port is a standard data port on a mobile electronic device.

12. The wireless recharging system of claim 1, wherein said data is a charge level of the rechargeable battery; such that the charge level is displayed on the display of the transmission device.

13. The wireless recharging system of claim 6, wherein said data is a charge level of the rechargeable battery of the mobile electronic device; such that the charge level is displayed on the display of the transmission device.

14. The wireless recharging system of claim 7, wherein said data is a charge level of the rechargeable battery of the mobile electronic device; such that the charge level is displayed on the display of the transmission device.

15. The wireless recharging system of claim 1, wherein said power source is an auxiliary AC socket of a vehicle; said transmission component providing electrical connectors which are capable of connecting with the auxiliary AC socket and transmitting power from the auxiliary AC socket to the capacitor and internal transmission magnetic coil.

16. The wireless recharging system of claim 15, wherein said transmission component is peanut in shape.

17. The wireless recharging system of claim 15, wherein said power port is a standard data port on a mobile electronic device.

18. The wireless recharging system of claim 16, wherein said power port is a standard data port on a mobile electronic device.

19. The wireless recharging system of claim 15, wherein said data is a charge level of the rechargeable battery; such that the charge level is displayed on the display of the transmission device.

20. The wireless recharging system of claim 16, wherein said data is a charge level of the rechargeable battery; such that the charge level is displayed on the display of the transmission device.
